(19) United States
(12) Patent Application Publication
(10) Pub. No.: US 2017/0053079 A1
(43) Pub. Date: Feb. 23, 2017

(54) SYSTEM AND METHODS FOR SCORING DATA TO DIFFERENTIATE BETWEEN DISORDERS

(71) Applicant: University of Massachusetts, Boston, MA (US)

(72) Inventors: David Cave, Wayland, MA (US); Neil Marya, Northborough, MA (US); Christopher Macomber, Worcester, MA (US)

(21) Appl. No.: 15/307,440

(22) PCT Filed: May 1, 2015
(86) PCT No.: PCT/US15/28741

§ 371 Date: Oct. 28, 2016

Related U.S. Application Data
(60) Provisional application No. 61/987,123, filed on May 1, 2014.

(51) Int. Cl. G06F 19/00

(52) U.S. Cl. CPC G06F 19/345; G06F 19/321; G06F 19/322

(57) ABSTRACT

A clinical scoring system and methods that effectively and efficiently utilizes a number of different data sources to determine a diagnosis of patient conditions. The score is compared to a spectrum of scores in order to identify between disorders, such as Inflammatory bowel disease (IBD) and irritable bowel syndrome (IBSd) or gastroesophageal reflux disease (GERD) and functional dyspepsia.

### CROSS-REFERENCE TO RELATED APPLICATIONS

This application claims the benefit of U.S. Provisional Patent Application No. 61/987,123 filed May 1, 2014, incorporated by reference.

### FIELD OF THE INVENTION

The invention relates generally to system and methods that facilitate a sequential infrastructure from which various clinical tools may be used to provide support for clinicians, improve the efficiency of diagnosis for many disease states, and serve as a two-way communication platform between electronic medical record systems and clinical trials databases. The invention includes automation and validation of data analysis with a user-friendly manual override or input ability. One preferred embodiment of the invention provides a means to differentiate and diagnose between two or more diseases through qualitative and quantitative analysis from multiple input sources, for example, differentiation and diagnosis between inflammatory bowel disease and irritable bowel disease or between gastroesophageal reflux disease and functional dyspepsia. The invention provides a scientific and accurate diagnostic system and methods that is reliable, simplified and cost efficient.

### BACKGROUND OF THE INVENTION

Traditional diagnosis of a gastrointestinal disorder is conducted upon a patient experiencing certain signs and symptoms that prompts the patient to schedule a visit with the primary care physician. A visit with the physician includes the review of the patients' medical history as well as a physical examination. The physician may recommend lab testing and/or radiology testing. Based on the test results, the patient may again return to visits with the primary care physician or may be referred to a gastrointestinal expert physician. The gastrointestinal expert physician may also recommend lab testing, radiology testing and/or an endoscopy exam. The time spent between visits with the primary care physician, gastrointestinal expert physician and tests may range from months to years to properly diagnose a gastrointestinal disorder.

In the diagnosis of medical conditions, diseases and disorders, the improvement and advancement of diagnostic tools becomes more accessible. With use of a multitude of sources and more doctors working to resolve issues affiliated with a single person, the management and evaluation of data continues to become overwhelmingly complex.

With this complexity, clinicians across multiple disciplines in medicine frequently encounter difficult-to-diagnose medical conditions which result in prolonged and expensive patient care paradigms, which are inefficient and can potentially delay appropriate care for patients, anywhere from months to many years. This is combined with a lack of integrated support tools for clinicians. Specifically, hospital medical records often exist independently of existing clinical support tools and the lack of communication between systems can be a hindrance with resulting increased cost and risk to patients.

Although the invention is described in reference to clinical scoring for gastroenterology, it is contemplated that the invention is applicable to differentiate and diagnose between any two or more diseases such as those related to endocrinology, hepatology, urology, and nephrology, to name a few.

In the digestive system, a number of gastrointestinal (GI) diseases are known that affect a number of tissues and organs along the GI tract, including the esophagus, stomach, small intestine, large intestine and rectum. A number of accessory organs of digestion may also be affected including the liver, gallbladder and pancreas. Diseases can be oral, esophageal, gastric, intestinal, and/or accessory digestive gland related.

In intestinal diseases the small and/or large intestines may be affected by physiological or pathological states. Acute conditions affecting the intestines may cause constipation or inflammation of the intestines, leading to obstruction or diarrhea. Inflammatory bowel disease (IBD) is a condition of unknown aetiology, classified as either Crohn's disease or ulcerative colitis that can affect the intestines and/or other parts of the GI tract. Irritable bowel syndrome (IBS) may cause constipation, diarrhea or an alternation pattern between constipation and diarrhea. Distinguishing from and properly diagnosing diarrhea predominant irritable bowel syndrome (IBSd) and IBD is a constant challenge in the medical community.

Similarly, it remains a challenge to distinguish between gastroesophageal reflux disease (GERD) and functional dyspepsia. GERD is a digestive disorder that affects the lower esophageal sphincter (LES), the ring of muscle between the esophagus and stomach, causing the return of the stomach's contents back up into the esophagus. Functional dyspepsia is also a form of impaired digestion, but contrary to GERD, is neurogenic based. Functional dyspepsia is typically characterized by chronic or recurrent pain in the upper abdomen, upper abdominal fullness and feeling full earlier than expected when eating. Although functional dyspepsia possesses signs and symptoms overlapping with GERD, it requires significantly distinct treatments and outcomes.

Millions of dollars are misspent in the diagnosis of these conditions. The Center for Disease Control (CDC) reports that the incidence of ulcerative colitis ranges from 0.5-24.5/100,000 persons worldwide while Crohn's ranges from 0.1-16/100,000 persons worldwide. Finding exact numbers for the prevalence of these conditions is hindered by the lack of gold standard criteria for diagnosis. However, the estimation is that 1.4 million persons in the United States have inflammatory bowel disease. Diagnosis is of necessity based on clinical criteria in the absence of any specific disease markers. This in turn leads to diagnostic confusion with the much more common condition IBSd, which also has no specific markers and is diagnosed on clinical criteria.

The diagnosis of IBS is currently found using the ROME diagnostic criteria. The diagnostic criteria reviews whether or not the patient experiences pain or abdominal discomfort as well as changes in stool or defecation regarding shape, form or passage as well as frequency of bowel movements. Diagnosis of IBS is thought of a condition of exclusion. In other words, IBS is usually diagnosed after all other causes of symptoms are ruled out. It can then easily be understood why IBS is frequently misdiagnosed with IBD. Regarding IBD, there is no single specific biological marker to identify Crohn's disease; rather it is diagnosed through a synthesis of clinical, biochemical, hematological, radiological, endoscopic and pathological features which may lead to a diagnosis of Crohn's disease. The Harvey-Bradshaw index is a simpler version of the Crohn's disease activity index, only consists of clinical parameters and does not utilize biochemical tests. Both of these tests are for assessing disease activity and are not diagnostic tools

Currently, there is no validated scoring system to differentiate IBD from IBSd and between GERD and functional dyspepsia. Differentiation is a clinical challenge facing both gastroenterologists and primary care physicians (PCPs). Currently, studies variably report clinical measures such as radiology, endoscopy, inflammatory markers, and symptoms to separate IBSd from IBD. Some of the available clinical diagnostic tools available include radiologic findings, endoscopy and biopsy results, inflammatory markers, and signs and symptoms. However PCPs do not have access to all available clinical diagnostic tools or must make diagnoses under limited time, money or tools constraints.

As suggested above, there is no current ‘gold standard’ for the diagnosis of IBD versus IBSd or GERD versus functional dyspepsia, or a combination of both—known as non-erosive reflux disease (NERD). This hampers research in this field as study populations are often created based on loose and ambiguous criteria and also delays care for patients in the clinical setting as their diagnoses can be delayed for months to years or missed entirely.

To complicate matters, GERD and functional dyspepsia may coexist—NERD—risking diagnostic confusion. The conditions are evaluated by history, endoscopic examination and if necessary measurement of pH levels in the esophagus. Proton pump inhibitor (PPI) agents were released to the market in 1990 and are a group of drugs whose main action is a pronounced and long-lasting reduction of gastric acid production.

It has been noted that in 2009 the five proton pump inhibitors take the first five places for expenditure for drugs and digestive diseases. Today, most complaints of pain or discomfort are treated with PPI agents. These agents are safe in the short term and provide only partial or no relief for patients with functional dyspepsia. Partial relief results in long-term use and exposes a large number of people to the long-term effects of PPIs which include an increased risk of gastrointestinal infection, the development of benign gastric polyps, osteoporosis, hypomagnesemia and possibly iron deficiency. However, PPI agents generally provide excellent relief of symptoms of GERD and allow healing of esophageal injury in these patients but are required long-term. Functional dyspepsia on the other hand is better treated with low-dose tricyclic antidepressants. Although these agents are not uniformly successful, their use along with dietary changes and behavioral modification are usually successful in eliminating symptoms without the use of long-term PPIs.

Therefore, there is a need for a system and methods to effectively and efficiently utilizing a number of different data sources to, ultimately, diagnose GI tract disease accurately. The invention satisfies this need by providing a scoring system and methods that assists in the diagnosis of patient conditions based on the available data from a number of input sources.

### SUMMARY OF THE INVENTION

Although the invention is discussed with respect to gastrointestinal disorders, the invention is applicable to all types of disorders of the body, for example, including those related to endocrinology, hepatology, urology, and nephrology. More specifically, the invention is applicable to any disorder in which the following may be obtained: radiological data, endoscopic data, pathology data, inflammatory data, biochemical data, physiological data, hematological and immunological data, microbiological data and data related to signs and symptoms.

The invention is a system and methods that facilitates the accurate diagnosis of different gastrointestinal disorders based on the quantification of multiple input data sources. The system is based on quantification of multiple clinical tests that are automatically analyzed to provide an accurate qualitative score used in the assessment of diagnosing a patient with a particular syndrome. For purposes of this application, the term syndrome is also referred to as disease or disorder.

According to the invention, the system is automated in its analysis with the option for a user override and manual input of additional data or scoring information to assist in the analysis process. The application of the invention may be utilized by a physician, nurse, medical staff and/or administration, or even the patient.

In certain embodiments of the invention, a diagnosis score may be integrated into a patient's electronic medical record. Furthermore, the diagnosis score may be uploaded into a clinical trial database, which may provide additional information about individual patients and/or allow a practitioner to enroll a patient in a clinical trial.

According to the invention, a diagnosis score may be used to differentiate between different conditions, for example, irritable bowel syndrome, irritable bowel disorder, gastroesophageal reflux disease, dyspepsia, multiple sclerosis, systemic lupus erythematous, rheumatoid arthritis, acute coronary syndrome, pericarditis, and the likewise. Furthermore, the diagnosis score may be validated based on a retrospective analysis of medical records of patients.

According to specific embodiments of the invention, a diagnosis score may be used to differentiate between a diagnosis of IBD and IBSd or between GERD and functional dyspepsia, conditions which can have overlapping signs and symptoms but significantly distinct treatments and outcomes. However, it is also contemplated that the invention may be used to determine overlap between two or more disorders resulting in a combined disorder, for example, non-erosive reflux disease or NERD, which is an overlap of GERD and functional dyspepsia.

With a diagnosis score used to differentiate between IBD and IBSd, diagnosis parameters obtained in patients being evaluated for the diseases may include, but is not limited to, radiological findings consistent with IBD, endoscopic findings consistent with IBD, biopsy findings consistent with IBD, elevated inflammatory markers (such as C-reactive protein (CRP), erythrocyte sedimentation rate (ESR), fecal calprotectin, and fecal lactoferrin) and signs and symptoms such as history of weight loss, history of hematochezia, extra-intestinal sign/symptoms, palpable mass on exam and/or perianal disease.

With a diagnosis score used to differentiate between GERD and functional dyspepsia, diagnosis parameters obtained in patients being evaluated for the diseases may include, but is not limited to, signs and symptoms such as intermittent or continuous symptoms, nocturnal waking, nausea, ascending pain, bloating, etc.

The numbers of patients with GERD and functional dyspepsia are so large that even a 50% reduction of unnecessary endoscopic interventions and appropriate use of medications translates into substantial cost savings and minimizes the risk of long-term PPI use in very large numbers of patients.

The invention provides asymptomatic separation of GERD from functional dyspepsia with at least two advantages. First, the clinical scoring according to the invention may reduce the number of patients requiring endoscopy as the first intervention to distinguish between the two conditions. For example, a patient with a score consistent with functional dyspepsia may be given a trial of low-dose try-cyclic antidepressants for use along with dietary management. Alternatively, a patient with a score suggestive of GERD may be prescribed a therapeutic trial of a PPI. Lastly, a patient with a score overlapping GERD and functional dyspepsia may suggest non-erosive reflux disease (NERD), which may best be diagnosed by endoscopy and 24hr pH or an impedance measurement.

According to the invention, weighted values may be assigned to certain diagnosis parameters during the evaluation and diagnosis of a condition. Weighted values may be in the form of points, markers, or numbers. The scoring system may be used by clinicians, especially primary care physicians, to assist in differentiating between two or more diagnoses. In addition, the scoring system may serve as a screening tool to further investigate diagnoses of similarly related diseases and disorders from the diagnosed condition.

It is also contemplated that the scoring system may be available to referral physicians to assist in assessing and evaluating the medical history of a patient. Similarly, the scoring system may be available to other medical staff or administration to further assist in assessing and evaluating the medical history of a patient.

The scoring system may also be used to standardize certain diagnosed populations in an academic research setting.

In certain embodiments, the invention may provide a portable means in which to review information related to a patient's diagnostic score compiled from a multitude of information sources. Information may include that related to the patient's name, medical record identification, diagnostic score, details of positive results leading to the diagnostic score, details on candidacy for clinical trials, options to include information in disease databases, options for monitoring or treatment of patient and allowing for referrals or follow-up visits with the patient.

The invention and its attributes and advantages may be further understood and appreciated with reference to the detailed description below of one contemplated embodiment, taken in conjunction with the accompanying drawings.

### BRIEF DESCRIPTION OF THE DRAWINGS

The preferred embodiments of the invention will be described in conjunction with the appended drawings provided to illustrate and not to limit the invention, where like designations denote like elements, and in which:

FIG. 1 illustrates a block diagram of a diagnosis system according to one embodiment of the invention.

FIG. 2 illustrates an exemplary computer system that may be used according to the invention.

FIG. 3 illustrates an exemplary cloud computer system that may be used according to the invention.

FIG. 4 is a flowchart of an example method according to the invention.

FIG. 5 illustrates a graph of an example experimental result according to the invention.

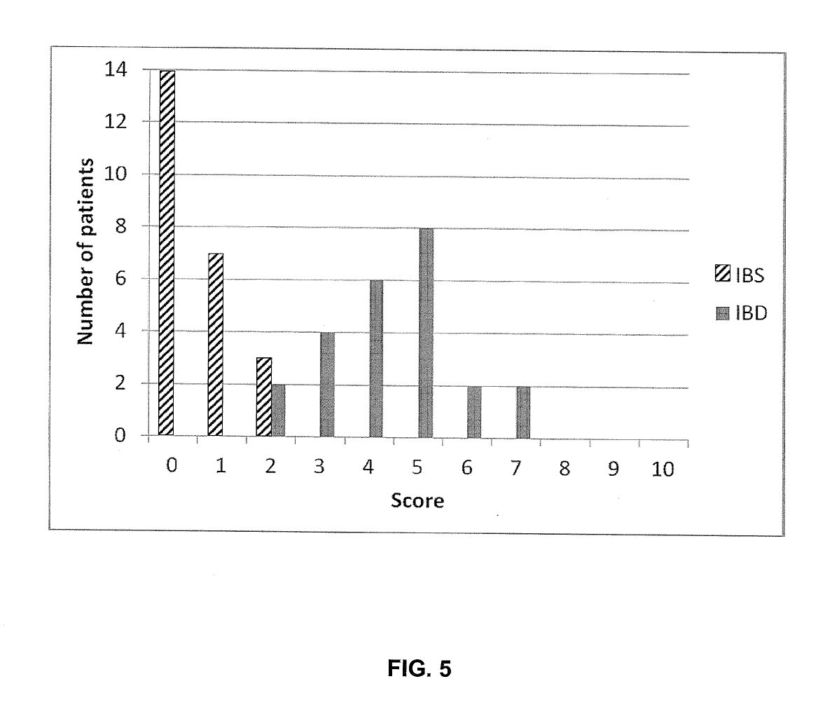

FIG. 6 illustrates a graph of an example experimental result according to the invention.

### DETAILED DESCRIPTION OF EMBODIMENTS OF THE INVENTION

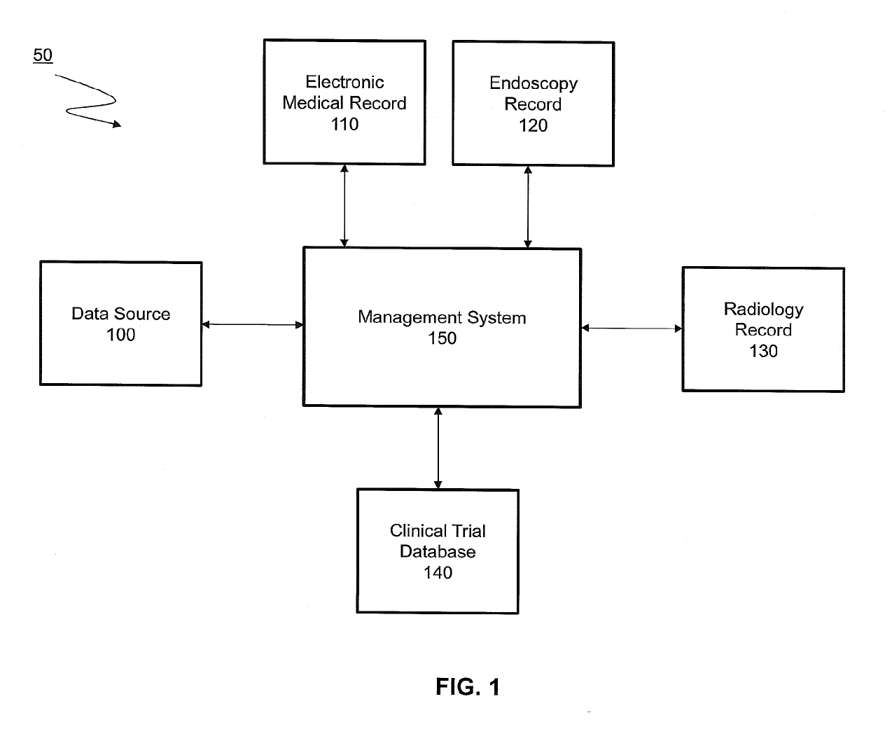

FIG. 1 illustrates a preferred embodiment of the diagnosis or scoring system 50 according to the invention. To utilize the scoring system 50 for differentiating different medical diagnosis according to the invention, a number of different databases or data sources 100 are utilized. Data sources 100 may produce any data resultant from laboratory tests, procedures, experienced signs and symptoms and includes, for example, radiology data, inflammatory marker data, and sign and symptom data, endoscopy data and the biopsy data.

This data may be gathered into the management system 150 from one or more data sources such as an electronic medical record (EMR) database 110, endoscopy record database 120, and radiology record database 130. However, it is contemplated that endoscopy data and/or radiology data may be provided to the management system 150 from the electronic medical record database 110.

Each data source 100 is input into the management system 150 to organize, assign, evaluate and diagnose a patient with a syndrome, disease, disorder or the likewise based on the summation of results from the compiled data sources 110, 120, 130. Upon a diagnosis of a patient, based on the processed data, the information will then be presented in one or more client computers. Each client computer allows for a user interface such as a display device in which data can be further analyzed and organized based on user feedback.

The management system 150 allows for the containment of data from multiple sources. The management system 150 may contain scores for multiple patients, which indicates a patient may have one or more medically diagnosed conditions. The management system 150 may automatically or manually interface with one or more data sources 100, for example the electronic medical record databases 110, otherwise referred to as data source, to provide and receive additional medical testing data that may be utilized towards the diagnosis of a patient. The management system 150 and electronic medical record database 110 may additionally interface with one or more clinical trial databases 140 for additional information exchange or to allow for enrollment in a clinical study and treatment.

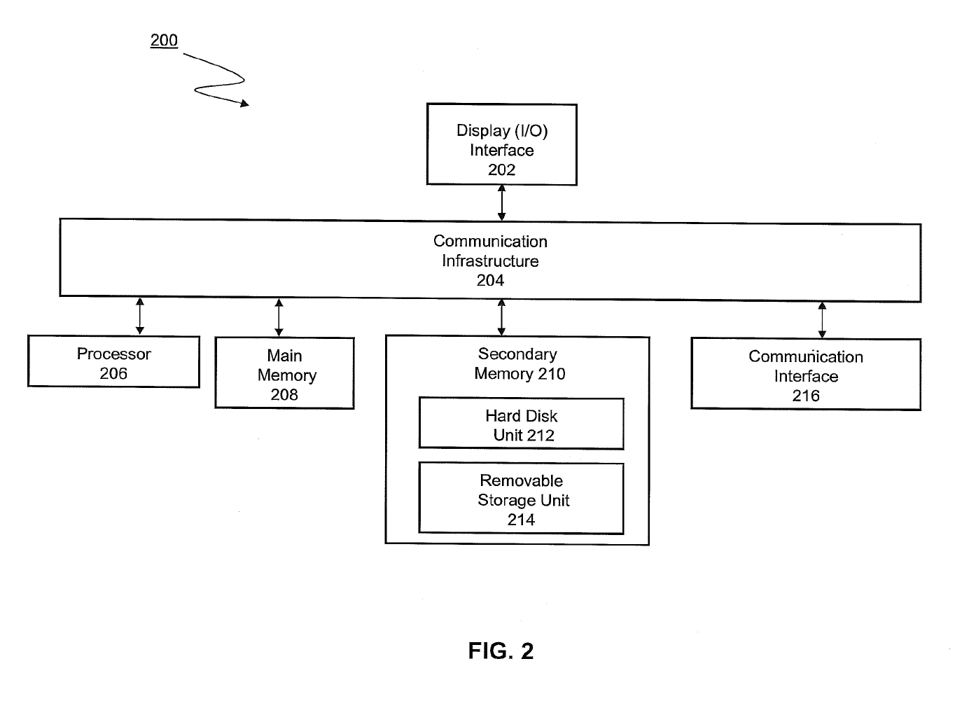

One embodiment of the management system 150 is shown in FIG. 2 as exemplary computer system 200. One or more computer systems 200 may be used to implement the methods according to the invention, for example as computer code.

Computer system 200 includes an input/output display interface 202 connected to communication infrastructure 204—such as a bus—that forwards data including graphics, text, and information, from the communication infrastructure 204 to other components of the computer system 200. The input/output display interface 202 may be, for example, a display device, a keyboard, touch screen, joystick, trackball, mouse, monitor, speaker, printer, Google Glass® unit, web camera, any other computer peripheral device, or any combination thereof, capable of entering and/or viewing data.

Computer system 200 includes one or more processors 206, which may be a special purpose or a general-purpose digital signal processor configured to process certain information. Computer system 200 also includes non-transitory computer-readable storage medium such as a main memory 208, for example random access memory (“RAM”), read-only memory (“ROM”), mass storage device, or any combination thereof. Computer system 200 may also include a secondary memory 210 such as a hard disk unit 212, a removable storage unit 214, or any combination thereof. Computer system 200 may also include a communication interface 216, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, etc.

It is contemplated that the main memory 208, secondary memory 210, communication interface 216, or a combination thereof, function as a non-transitory computer-readable storage medium to store and/or access computer software including computer instructions. Certain embodiments of a computer readable storage medium do not include any transitory signals or waves. For example, computer programs or other instructions may be loaded into the computer system 200 such as through a removable storage device, for example, a floppy disk, ZIP disks, magnetic tape, portable flash drive, optical disk such as a CD or DVD or Blu-ray, Micro-Electro-Mechanical Systems (“MEMS”), nanotechnological apparatus. Specifically, computer software including computer instructions may be transferred from the removable storage unit 214 or hard disc unit 212 to the secondary memory 210 or through the communication infrastructure 204 to the main memory 208 of the computer system 200.

Communication interface 216 allows software, instructions and data to be transferred between the computer system 200 and external devices or external networks. Software, instructions, and/or data transferred by the communication interface 216 are typically in the form of signals that may be electronic, electromagnetic, optical or other signals capable of being sent and received by the communication interface 216. Signals may be sent and received using wire or cable, fiber optics, a phone line, a cellular phone link, a Radio Frequency (“RF”) link, wireless link, or other communication channels.

Computer programs, when executed, enable the computer system 200, particularly the processor 206, to implement the methods of the invention according to computer software including instructions.

The computer system 200 described herein may perform any one of, or any combination of, the steps of any of the methods presented herein. It is also contemplated that the methods according to the invention may be performed automatically, or may be invoked by some form of manual intervention.

The computer system 200 of FIG. 2 is provided only for purposes of illustration, such that the invention is not limited to this specific embodiment. It is appreciated that a person skilled in the relevant art knows how to program and implement the invention using any computer system such as a cloud computer system.

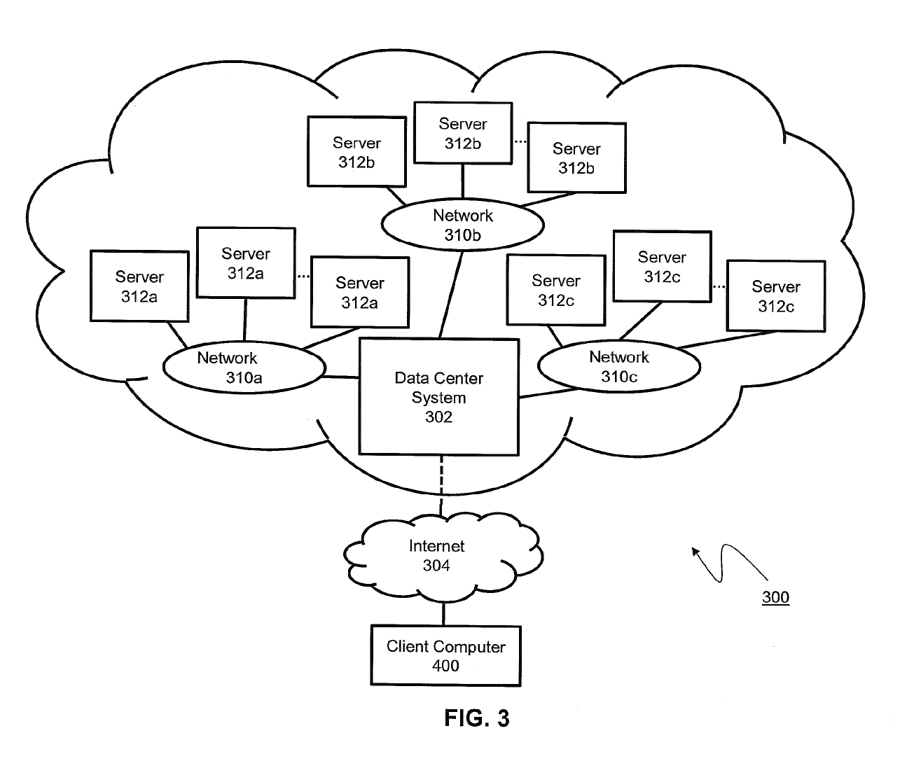

Another embodiment of the management system 150 is shown in FIG. 3 as exemplary cloud computer system 300. One or more cloud computer systems 300 may be used to implement the methods according to the invention, for example as computer code processed by a processor such as one similar to that described in reference to FIG. 2.

FIG. 3 illustrates an exemplary cloud computer system 300 that may be used according to the invention. Cloud computing systems involves deploying groups of remote servers and software networks that allow different kinds of data sources to be uploaded for real time processing to generate computing results without the need to store processed data on local machines.

More specifically, the cloud computer system 300 includes a plurality of interconnected computing environments. The cloud computer system 300 utilizes the resources from various networks as a collective virtual computer, where the services and applications can run independently from a particular computer or server configuration making hardware less important.

Specifically, the cloud computer system 300 includes at least one client computer 400. The client computer 400 may be any device through the use of which a distributed computing environment may be accessed to perform the methods disclosed herein, for example, a traditional computer, portable computer, handheld device, mobile phone, personal digital assistant, smart hand-held computing device, cellular telephone, or a laptop or netbook computer, hand held console or MP3 player, tablet, or similar hand held computer device, such as an iPad®, iPad Touch® or iPhone®. More specifically, the client computer 400 may include one or more components as described in reference to the computer system of FIG. 2.

The client computer 400 establishes communication with the Internet 304 to one or more servers to, in turn, establish communication with one or more cloud data centers 302. The cloud computer system 300 includes one or more networks 310a, 310b, 310c managed through a data center system 302. Each network 310a, 310b, 310c includes resource servers 312a, 312b, 312c, respectively. Servers 312a, 312b, 312c permit access to a collection of computing resources and components that can be invoked to instantiate a virtual machine, process, or other resource for a limited or defined duration. For example, one group of resource servers can host and serve an operating system or components thereof to deliver and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software.

The cloud computer system 300 can comprise a dedicated or centralized server and/or other software, hardware, and network tools to communicate with one or more networks 310a, 310b, 310c, such as the Internet or other public or private network, with all sets of resource servers 312a, 312b, 312c. The data center system 302 may be configured to query and identify the computing resources and components managed by the set of resource servers 312a, 312b, 312c needed and available for use with the data center system 302.

The invention is also directed to computer products, otherwise referred to as computer program products, to provide software to the cloud computer system 300. Computer products store software on any computer useable medium, known now or in the future. Such software, when executed, may implement the methods according to certain embodiments of the invention. The cloud computer system 300 of FIG. 3 is provided only for purposes of illustration and does not limit the invention to this specific embodiment. It is appreciated that a person skilled in the relevant art knows how to program and implement the invention using any computer system or network architecture.

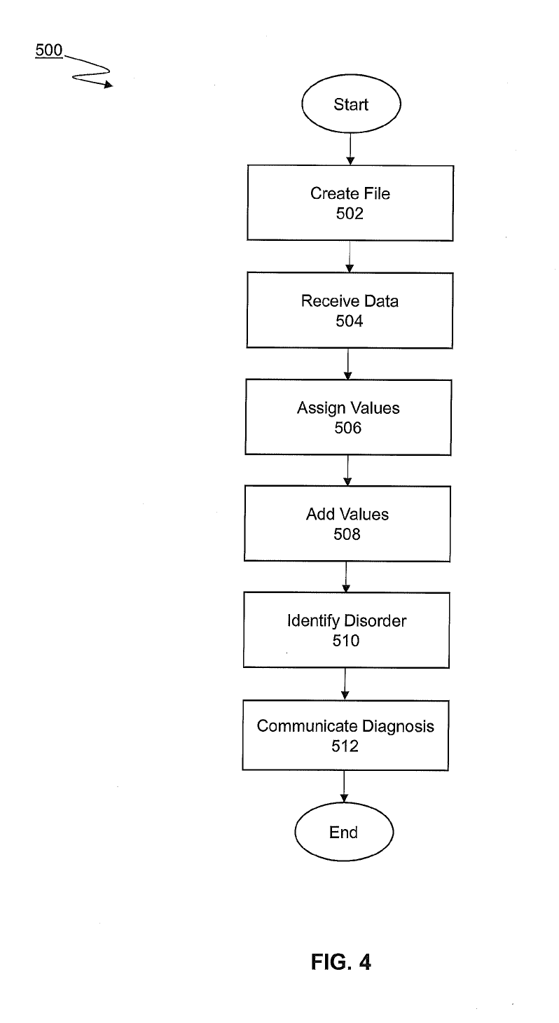

FIG. 4 is a flowchart of an example method for facilitating the analysis and scoring of clinical data according to the invention. A patient schedules a visit with the primary care physician. The visit with the physician includes the review of the patient's medical history as well as a physical examination. The physician may further recommend lab testing and/or radiology testing to obtain data.

As shown in FIG. 4, a patient file is created at step 502. The file may be an electronic medical record including, for example, one that resides in the cloud computer system as described in reference to FIG. 3.

A diagnosis of a gastrointestinal disorder is conducted according to a scoring method using data from a variety of data sources. At step 504, data is received from a variety of data sources. Data includes, for example, radiology data, inflammatory marker data, and sign and symptom data, endoscopy data and the biopsy data. It is contemplated that a physician may manually adjust imported data, values or data points to create a user-friendly report, which may be printed, shared or stored for later use.

The analysis and scoring of clinical data is used to differentiate between disorders of a patient such as those relating to the gastrointestinal tract. In one embodiment of the invention, the scoring method differentiates between inflammatory bowel disease (IBD) and irritable bowel syndrome (IBSd). In another embodiment of the invention, the scoring method differentiates between gastroesophageal reflux disease (GERD) and functional dyspepsia.

At step 506, values are determined from a review of the data. In one embodiment according to the invention, when radiology data is consistent with a first disorder such as IBD or GERD, a first value is assigned to the patient file. The first value may be a numerical value or other designation such as one point. In another embodiment, the patient file is allocated one point when inflammatory marker data is present. Inflammatory marker data includes, for example, one or more selected from the group comprising: C-reactive protein (CRP), erythrocyte sedimentation rate (ESR), fecal calprotectin, and fecal lactoferrin.

In yet another embodiment, one point is apportioned to the patient file for each sign and symptom data. In certain embodiments of the scoring method, the maximum number of points for sign and symptom data is a five point value. Sign and symptom data may include for example, one or more selected from the group comprising: weight loss, history of hematochezia, extra-intestinal sign/symptom, palpable mass on exam and/or perianal disease. Furthermore, sign and symptom data may include intermittent or continuous symptoms, nocturnal waking, nausea, ascending pain, bloating, etc.

In certain other embodiments of the invention, endoscopy data and biopsy data is collected from different data sources. One point is designated to the patient file for each endoscopy data with a maximum point value possible such as two points. Endoscopy data may be directed to one or more of inflammation and ulceration. One point is assigned when biopsy data is consistent with a particular disorder such as IBD or GERD.

At step 508, all the values are added to obtain a final point value of the patient file. The final value is compared to a spectrum of scores. The spectrum of scores includes a first range identifying the first disorder and a second range identifying a second disorder. As an example, the spectrum of scores is 0 to 10 with a first range of 2 to 10 identifying inflammatory bowel disease (IBD) and a second range of 0 to 2 identifying irritable bowel syndrome (IBSd). The spectrum of scores and ranges are merely exemplary, any value spectrum of scores and ranges is contemplated. However any range is contemplated such as a first range of 1 to 4 and a second range of 0 to 1.

In alternate embodiments of the invention, the value for each piece of data may be equal to each data source or be a higher or weighted value if, for example, a patient is more likely to have a particular diagnosis based on having a positive test, sign, symptom or the like with one particular data source. Such weighted values may be automatically programmed as a default value or may be manually adjusted by the user based on the needs of the patient.

Once it is determined where the final value resides in the spectrum, the patient file can be classified and the disorder identified at step 510. At step 512, the diagnosis is communicated such as through a display interface.

Based on the diagnostic score, the patient may be referred to a gastrointestinal expert physician or directly treated for the diagnosed gastrointestinal disorder. If the patient is referred to the gastrointestinal expert physician, the gastrointestinal expert physician may also recommend additional lab testing such as a colonoscopy, capsule endoscopy or deep enteroscopy or biopsy. With use of a diagnostic score, the primary care physician may properly diagnose the given gastrointestinal disorder while simultaneously saving time and money. Furthermore, the score may validate the diagnosis score obtained during the primary care physician consultation. The patient may then be recommended by the gastrointestinal expert physician to enroll in a clinical trial.

The following are examples illustrating the features of the invention.

### EXAMPLES

Patient referral example: Consider a 29 year old female patient (JG) who has been having worsening abdominal pain and diarrhea for the past 7 months. JG initially did not see a physician for her complaints, but as her symptoms were not improving she went to her Primary Care Physician (PCP) for evaluation. As part of the initial evaluation, the PCP noted that JG has had weight loss (10 pounds over 6 months) and some occasional bleeding. The PCP then orders a set of inflammatory markers to check if JG may have signs of inflammatory bowel disease. The three inflammatory markers (ESR, CRP, and fecal calprotectin) came back within a week and only the ESR is slightly elevated. The PCP chooses a watchful waiting approach and asks the patient to come back for follow up in 4-6 weeks. Over this time period JG has not been able to go to work due to the worsening abdominal pain and frequent episodes of diarrhea. She comes back to see her PCP for her follow up appointment and at that point is noted to have lost an additional 3-4 pounds. Given the persistent weight loss, the PCP orders the patient to have a CT scan of her abdomen which does not demonstrate any focal signs suggestive of inflammatory bowel disease. Given this result the PCP tells the patient to follow up in 3-4 months and prescribes Imodium (a medication to slow diarrhea) and has the patient see a nutritionist. At the next visit, the patient appears quite ill and has now lost even more weight. At this point, the patient is referred to see a gastroenterologist who sees the patient and recommends a colonoscopy. The colonoscopy shows patchy inflammation and biopsies confirm inflammatory bowel disease.

In this same patient scenario but with diagnostic scoring available to the PCP, at the initial visit the PCP would already be able to give the patient two points (for having weight loss and bleeding). Once an inflammatory marker came back positive that gives the patient a total of three points. Based on the studies we have performed, a diagnostic score of three is highly suggestive of inflammatory bowel disease. The diagnostic method would then advise the PCP to refer the patient to a Gastroenterologist for more extensive evaluation and treatment. This would minimize wait time before a referral to a gastrointestinal physician and the patient could receive appropriate treatment at an earlier point.

Diagnosis validation example: In a preliminary study to validate the system, two study cohorts were identified. Subjects in Group 1 were well-established patients with known Crohn's or ulcerative colitis. Subjects in Group 2 were identified as having IBSd based on ROME III criteria. Retrospective analysis of the medical records was performed and a diagnosis score was calculated for each patient. One point is assigned for having each of the following: radiological findings consistent with IBD, endoscopic findings of inflammation, endoscopic findings of ulceration, biopsy findings consistent with IBD, elevated inflammatory markers (such as sedimentation rate, C-reactive protein or fecal calprotectin), weight loss, hematochezia, extra-intestinal signs/symptoms, palpable mass on exam, and perianal disease. The maximum score is 10 points. For the score, the same clinical criteria were studied with the exclusion of endoscopic and biopsy findings. Maximum score for that system is 8 points. A likelihood ratio chi-square test was performed for both cohorts and scoring systems.

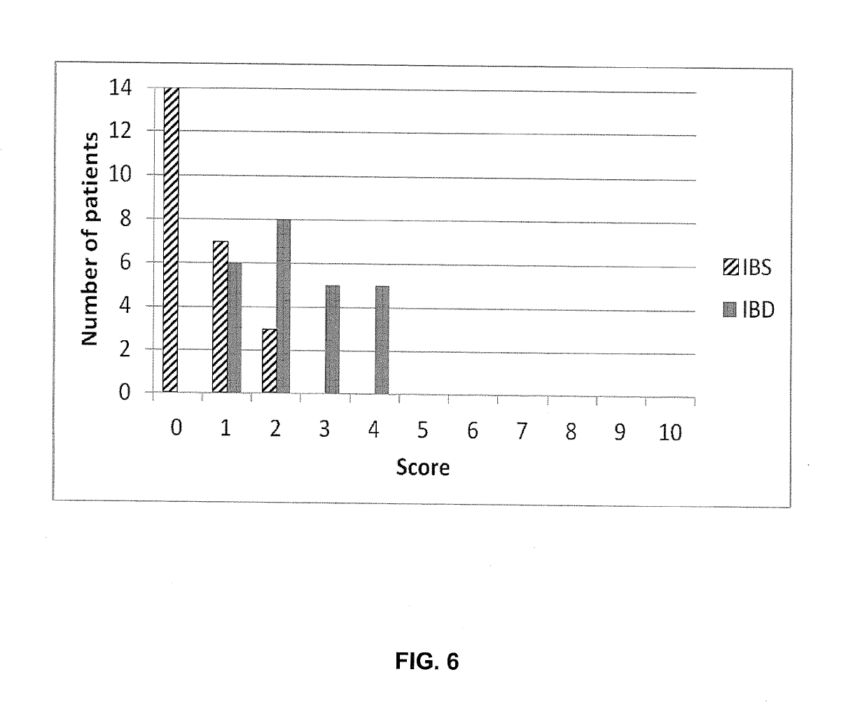

FIG. 6 demonstrates that, through utilizing the scoring system according to the invention, a significant differentiation of the two cohorts in regards to scoring distribution is found (chi-square value=59.8; p<0.0001). The distribution analysis shows that Group 1 scores ranged from 2 to 10 while Group 2 scores ranged from 0 to 2.

FIG. 7 demonstrates that, through utilizing the scoring system of the invention, a significant differentiation of the two cohorts is also found (chi-square value=35.7; p<0.0001). Group 1 scores ranged from 1 to 4 while Group 2 scores ranged from 0 to 2.

Cloud-based data conferment example: In a hypothetical example, consider a research institution seeking to study a new diagnostic blood test that will differentiate inflammatory bowel disease (IBD) from diarrhea-predominant irritable bowel syndrome (IBSd). Historically, these two conditions are difficult to differentiate and the treatments for the two conditions vary greatly. When creating the cohort populations for their study, the researchers ask for the associated Gastroenterology Clinic to provide 50 patients with IBSd and 50 patients with IBD.

The Gastroenterology clinic searches through their list and picks 50 patients with IBD and 50 patients with IBSd. In choosing these patients, however, the Gastroenterologists state that the researchers must include in their paper that these patients were chosen using ‘clinical criteria’ for which there is no current gold standard to differentiate these two conditions. Hence, the clinicians cannot be sure that these patients have these conditions and that there is consistency in the diagnosis of each patient based on their signs, symptoms and test results. As such, the clinical study that is performed is based on study populations that are not defined by a gold standard and, therefore, the diagnostic test cannot be firmly established given this study.

Now consider if the Gastroenterologists had been using a diagnostic scoring method and the Cloud-based system to accumulate a database. In that scenario, patient's being evaluated for IBD or IBS in their clinics would have diagnostic scores calculated as part of their visits. The diagnostic scores and patient information to the EMR would be fed into a clinical trial database. Patients with diagnostic scores >2 would be validated as having IBD. The higher the score the greater the likelihood of the patient having IBD, whereas those with scores ≦2 would be validated as having IBS.

While the disclosure is susceptible to various modifications and alternative forms, specific exemplary embodiments of the invention have been shown by way of example in the drawings and have been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

1. A method for facilitating the analysis and scoring of clinical data to differentiate between disorders of a patient comprising the steps of:
creating a patient file;
receiving into the patient file radiology data, inflammatory marker data, and sign and symptom data of the patient, each of the radiology data, the inflammatory marker data and the sign and symptom data received from one or more data sources;
assigning to the patient file a first numerical value when the radiology data is consistent with a first disorder;
allocating to the patient file a second numerical value when inflammatory marker data is present;
apportioning to the patient file a third numerical value, the third numerical value a summation of each value assigned to each sign and symptom data;
adding the first numerical value, the second numerical value and the third numerical value to obtain a final value of the patient file;
comparing the final value of the patient file to a spectrum of scores, the spectrum of scores including a first range identifying the first disorder and a second range identifying a second disorder; and
determining whether the final value resides in the first range or the second range;
classifying the patient file with a diagnosis of the first disorder or the second disorder; and
communicating the diagnosis.

2. The method for facilitating the analysis and scoring of clinical data to differentiate between disorders of a patient according to claim 1, wherein the receiving step further comprises the step of:
collecting into the patient file endoscopy data and biopsy data of the patient, each of the endoscopy data and the biopsy data received from the one or more data sources.

3. The method for facilitating the analysis and scoring of clinical data to differentiate between disorders of a patient according to claim 2 further comprising the steps of:
designating to the patient file a fourth numerical value and a fifth numerical value, the fourth numerical value a summation of each value assigned to each endoscopy data and the fifth numerical value assigned when the biopsy data is consistent with the first disorder;
totaling the fourth numerical value and the fifth numerical value to obtain a total value; and
including the total value with the final value of the patient file.

4. The method for facilitating the analysis and scoring of clinical data to differentiate between disorders of a patient according to claim 1, wherein the diagnosis relates to the gastrointestinal tract.

5. The method for facilitating the analysis and scoring of clinical data to differentiate between disorders of a patient according to claim 1, wherein the first disorder is inflammatory bowel disease (IBD) and the second disorder is irritable bowel syndrome (IBSd).

6. The method for facilitating the analysis and scoring of clinical data to differentiate between disorders of a patient according to claim 1, wherein the first disorder is gastroesophageal reflux disease (GERD) and the second disorder is dyspepsia.

7. The method for facilitating the analysis and scoring of clinical data to differentiate between disorders of a patient according to claim 1, wherein the inflammatory marker data includes one or more selected from the group comprising: C-reactive protein (CRP), erythrocyte sedimentation rate (ESR), fecal calprotectin, and fecal lactoferrin.

8. The method for facilitating the analysis and scoring of clinical data to differentiate between disorders of a patient according to claim 1, wherein the sign and symptom data is one or more selected from the group comprising: weight loss, history of hematochezia, extra-intestinal sign/symptom, palpable mass on exam and/or perianal disease.

9. The method for facilitating the analysis and scoring of clinical data to differentiate between disorders of a patient according to claim 2, wherein the endoscopy data is directed to one or more of inflammation and ulceration.

10. The method for facilitating the analysis and scoring of clinical data to differentiate between disorders of a patient according to claim 2, wherein the biopsy data is consistent with the first disorder.

11. The method for facilitating the analysis and scoring of clinical data to differentiate between disorders of a patient according to claim 1, wherein the spectrum of scores is 0 to 10.

12. The method for facilitating the analysis and scoring of clinical data to differentiate between disorders of a patient according to claim 1, wherein the first range is 2 to 10.

13. The method for facilitating the analysis and scoring of clinical data to differentiate between disorders of a patient according to claim 1, wherein the first range is 1 to 4.

14. The method for facilitating the analysis and scoring of clinical data to differentiate between disorders of a patient according to claim 1, wherein the second range is 0 to 2.

15. A method for facilitating the analysis and scoring of clinical data to differentiate between disorders of a patient comprising the steps of:
creating a patient file;
receiving into the patient file radiology data, inflammatory marker data, sign and symptom data of the patient, endoscopy data and biopsy data of the patient, each of the data received from the one or more data sources;
assigning to the patient file:
one point value for the radiology data consistent with a first disorder,
one point value for the presence of inflammatory marker data,
one point value or each presence of sign and symptom data with a maximum of a five point value,
one point value for each presence of endoscopy data with a maximum of a two point value,
one point value for the biopsy data consistent with a first disorder,
adding all point values to obtain a final point value of the patient file;
identifying a first disorder or a second disorder associated with the patient file, wherein the final point value between and including 0 and 2 identifies the second disorder; and
displaying a diagnosis for the patient file.

16. The method for facilitating the analysis and scoring of clinical data to differentiate between disorders of a patient according to claim 15, wherein the final point value between and including 2 and 10 identifies the first disorder.

17. The method for facilitating the analysis and scoring of clinical data to differentiate between disorders of a patient according to claim 15, wherein the final point value between and including 1 and 4 identifies the first disorder.

18. The method for facilitating the analysis and scoring of clinical data to differentiate between disorders of a patient according to claim 15, wherein the first disorder is inflammatory bowel disease (IBD).

19. The method for facilitating the analysis and scoring of clinical data to differentiate between disorders of a patient according to claim 15, wherein the first disorder is gastroesophageal reflux disease (GERD).

20. A method for facilitating the analysis and scoring of clinical data to differentiate between disorders of a patient comprising the steps of:
creating a patient file;
receiving into the patient file sign and symptom data of the patient received from one or more data sources;
assigning to the sign and symptom data of the patient file:
one point value for intermittent sign and symptom data,
one point value for nocturnal waking,
one point value for ascending pain,
adding all point values to obtain a final point value of the patient file;
identifying a first disorder or a second disorder associated with the patient file, wherein the final point value between and including 0 and 1 identifies the first disorder or the final point value between and including 0 and 3 identifies the second disorder; and
displaying a diagnosis for the patient file.
